(19) United States
(12) Patent Application Publication
(10) Pub. No.: US 2007/0228103 A1
(43) Pub. Date: Oct. 4, 2007

(54) Solder spray jig

(75) Inventors: Kuo-Ching Chuang, Taipei (TW); Chin-Lung Chen, Taipei (TW)

Correspondence Address: FULBRIGHT AND JAWORSKI LLP, 555 S. FLOWER STREET, 41ST FLOOR, LOS ANGELES, CA, 90071, US

(73) Assignee: INVENTEC CORPORATION

(21) Appl. No.: 11/393,522

(22) Filed: Mar. 29, 2006

(51) Int. Cl. B23K 1/00; B23K 20/08

(52) U.S. Cl. 228/32; 228/33

(57) ABSTRACT

A solder spray jig includes: a main body having an opening acting as a spray outlet for solder, and recesses formed on two opposite sides of the main body and communicating with the spray outlet; a movable unit disposed on each of the two opposite sides of the main body, for covering and exposing a corresponding one of the recesses; and a driving device mounted to the movable units, for allowing the movable units to be operationally associated with each other to cover and expose the recesses. The spray outlet of the main body can keep abutting against a mold that covers a circuit board having electronic components when the main body is being moved horizontally in relation to the mold, so as to spray the solder via the spray outlet to effectively fix the electronic components to the circuit board.

### FIELD OF THE INVENTION

The present invention relates to a system and method for searching target devices within the same subnet, and more particularly, to a system and method that enables a master control device to automatically and quickly search target devices within the same subnet.

The present invention relates to jigs, and more particularly, to a solder spray jig.

### BACKGROUND OF THE INVENTION

Electronic components mounted on a circuit board mostly have electrical pins thereof being inserted in the circuit board and bonded to a back surface of the circuit board via solder balls so as to fix the electronic components on the circuit board.

For a large circuit board with a large number of electronic components being disposed thereon, it would be very time-consuming to solder the pins of the electronic components one by one to the circuit board. Therefore, at present a spraying method is applied to spraying the solder over the back surface of the circuit board to fix the large number of pins. As there are some structures, such as circuits, on the circuit board, which must not be in contact with the solder, a mold is necessarily applied over the back surface of the circuit board, and the mold is formed with openings corresponding in position to the pins that are to be fixed via the solder. By applying the spraying method, the electronic components can be firmly mounted to the circuit board rapidly by means of the sprayed solder.

In order to spray the solder intensively, the solder is sprayed into a jig in a high speed in advance. The jig is formed with a long-strip shaped opening to release the solder and the opening faces upwards. The mold is placed on the jig, and the circuit board is placed on the mold, allowing the jig to move horizontally in relation to the mold to spray the solder to all the openings of the mold. In consideration of spraying speed and efficiency, if the opening of the jig abuts against the mold, the optimal spraying efficiency can be achieved and also a motor for driving flow of the sprayed solder can operate in a relatively low revolution rate.

Besides the circuits, there may also be some attached components, such as an attachment board, mounted on the back surface of the circuit board, thereby making the mold need to have corresponding protruding portions to accommodate the attached components. By such arrangement, the jig must be spaced from the mold by a certain distance to spray the solder to the mold, such that the original spraying speed set for spraying the solder with the jig abutting against the mold, would become ineffective to spray an enough amount of the solder to the circuit board. Thereby, the revolution rate of the motor should be increased to provide a larger spraying speed, which causes increase in electricity consumption and solder usage after long-term operation.

Furthermore, even though increasing the revolution rate of the motor can increase the solder spraying speed, when the attached components of the circuit board exceed a certain height, the amount of solder being applied to the circuit board may not meet a required standard.

Therefore, the problem to be solved here is to provide a solder spray jig to overcome the foregoing drawbacks in the prior art.

### SUMMARY OF THE INVENTION

In light of the above drawbacks in the prior art, an objective of the present invention is to provide a solder spray jig that can keep abutting against a mold when the solder spray jig is spraying solder.

Another objective of the present invention is to provide a solder spray jig to increase the spraying efficiency.

A further objective of the present invention is to provide a solder spray jig to reduce the cost.

In accordance with the above and other objectives, the present invention proposes a solder spray jig comprising: a frame-shaped main body comprising an opening acting as a spray outlet for solder, and recesses formed on two opposite sides of the main body and communicating with the spray outlet; a movable unit disposed on each of the two opposite sides of the main body, for covering and exposing a corresponding one of the recesses; and a driving device mounted to the movable units on the two opposite sides of the main body, for allowing the movable units to be operationally associated with each other to cover and expose the recesses. The spray outlet of the main body can abut against a mold that covers a circuit board, and the main body is movable horizontally in relation to the mold. The circuit board is provided with an attached component and a plurality of electronic components, and the mold is formed with openings corresponding in position to pins of the electronic components and a protruding portion for accommodating the attached component. When the main body is being moved horizontally in relation to the mold and the protruding portion of the mold is in contact with at least one of the movable units, the movable units are urged to expose the recesses by means of the driving device, to allow the protruding portion to pass through the recesses of the main body and allow the spray outlet to keep abutting against the mold during the movement of the main body, such that a sufficient amount of the solder can be sprayed to the pins of the electronic components to fix the electronic components to the circuit board.

The solder is extracted by a fluid dynamic bearing motor from a hotflow device where the solder is generated. In order to evenly spray the solder to the circuit board, the circuit board is disposed on the mold, and the main body of the solder spray jig is disposed under the mold, allowing the spray outlet to spray the solder upwards. The attached component can be an attachment board, which is protruded from the circuit board by at least 12 mm.

Preferably, the movable units are movable doors pivotally mounted to the main body, and are operationally associated with each other by means of the driving device. The driving device comprises a frame and a rod that are pivotally connected to each other. An end of the frame, opposite to the end thereof connected to the rod, is pivotally connected to one of the movable units. An end of the rod, opposite to the end thereof connected to the frame, is pivotally connected to the other one of the movable units.

Compared with the prior art where the jig must be spaced from the mold by a certain distance and causes an insufficient amount of solder being applied to the circuit board, the solder spray jig of the present invention can allow the spray outlet to keep abutting against a surface of the mold to provide sufficient solder to the circuit board and achieve an optimal spraying effect, thereby overcoming the drawbacks of the prior art.

Furthermore, when the conventional jig reaches the protruding portion of the mold, the revolution rate of the motor is increased to provide an increased solder spraying speed to apply a standard amount of solder to the circuit board. On the contrary, as the solder spray jig of the present invention keeps abutting against the mold, there is no need to increase a revolution rate of the motor but a sufficient amount of the solder can still be provided to the circuit board, thereby overcoming the drawbacks in the prior art such as increase in electricity consumption and solder usage. The solder spray jig of the present invention is also advantageously applicable to various kinds of molds.

### BRIEF DESCRIPTION OF THE DRAWINGS

The present invention can be more fully understood by reading the following detailed description of the preferred embodiments, with reference made to the accompanying drawings, wherein:

FIGS. 1A and 1B are schematic diagrams of a solder spray jig according to a preferred embodiment of the present invention;

FIG. 2 is a cross-sectional view of the solder spray jig according to the present invention being applied to a spraying process; and

FIG. 3 is a bottom view of the solder spray jig according to the present invention being applied to the spraying process.

### DETAILED DESCRIPTION OF THE PREFERRED EMBODIMENTS

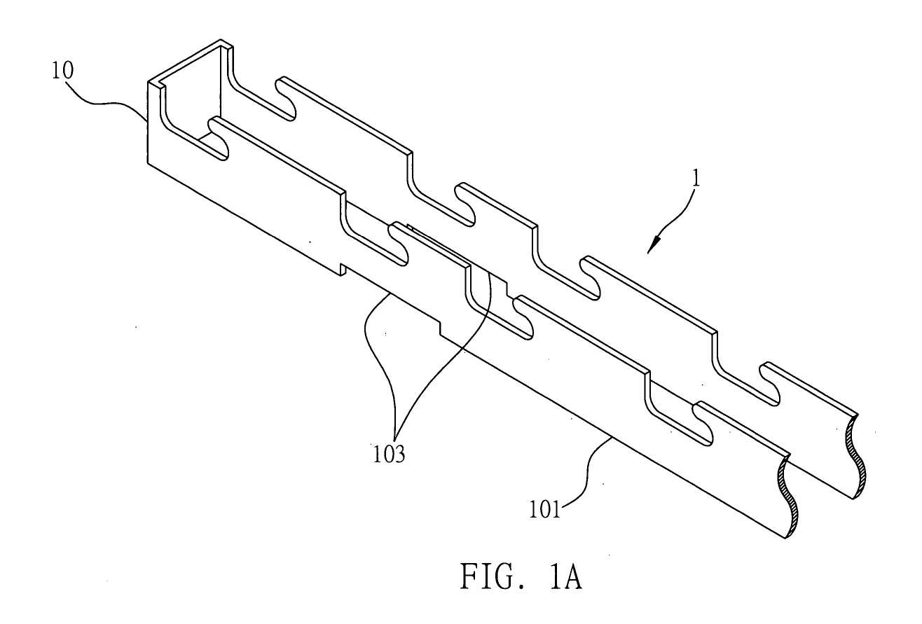

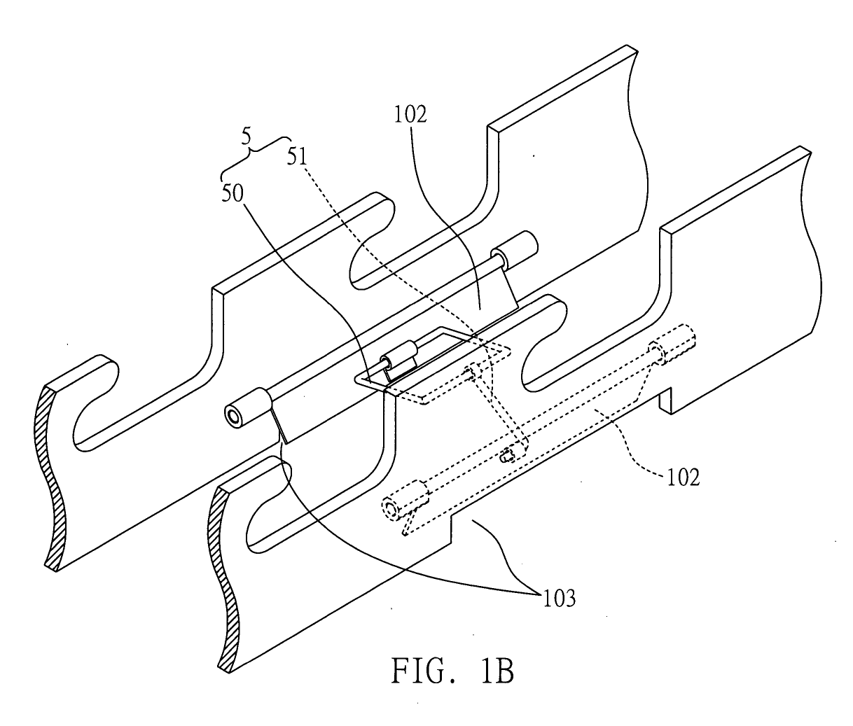

Preferred embodiments of a solder spray jig proposed in the present invention are described as follows with reference to FIGS. 1 to 3. It is to be noted that the drawings are simplified schematic diagrams and only show components relating to the present invention. In practice, the layout of components could be more complicated. It should be understood that the following embodiments are not construed to limit the scope of the present invention.

As shown in FIG. 1A, a solder spray jig 1 of the present invention comprises: a frame-shaped main body 10 comprising an opening having a flat kerf to act as a spray outlet 101 for solder, and recesses 103 formed on two opposite sides of the main body 10, the recesses 103 communicating with the spray outlet 101.

The main body 10 can accommodate a solder sprayer therein. The solder is extracted to the solder sprayer by a fluid dynamic bearing (FDB) motor from a hotflow device (both not shown) where the solder is generated, and the solder is sprayed by the solder sprayer in the main body 10 in a high speed and then is sprayed out via the spray outlet 101.

As shown in FIG. 1B, the solder spray jig 1 further comprises: a movable unit 102 disposed on each of the two opposite sides of the main body 10, for covering and exposing a corresponding one of the recesses 103; and a driving device 5 mounted to the movable units 102, for allowing the movable units 102 to be operationally associated with each other to cover and expose the recesses 103. The movable units 102 can be movable doors pivotally mounted to the main body 10. The driving device 5 comprises a frame 50 and a rod 51 that are pivotally connected to each other. An end of the frame 50, opposite to the end thereof connected to the rod 51, is pivotally connected to one of the movable units 102. An end of the rod 51, opposite to the end thereof connected to the frame 50, is pivotally connected to the other one of the movable units 102. By means of the driving device 5, the movable units 102 on the two opposite sides of the main body 10 can operate at the same time to cover and expose the recesses 103.

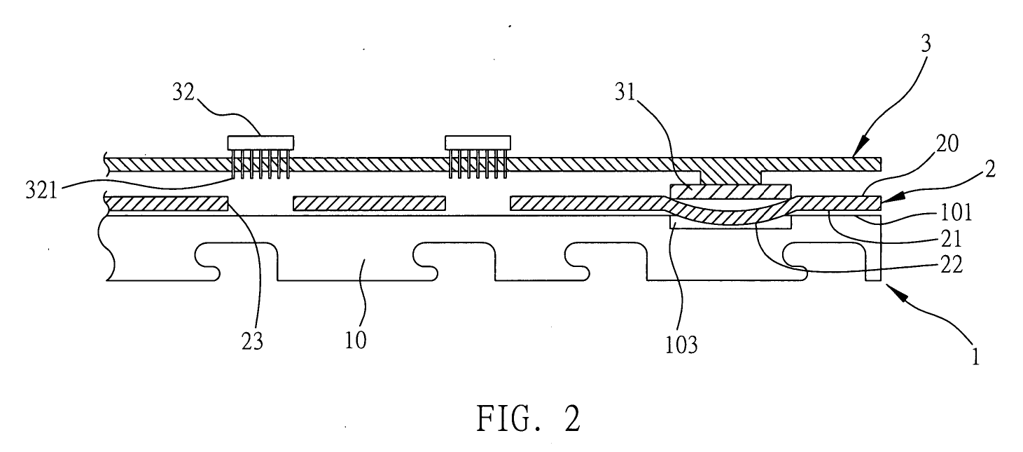

Referring to FIG. 2, the spray outlet 101 abuts against a surface 21 of a mold 2, and another surface 20 of the mold 2 abuts against a circuit board 3. In order to evenly spray the solder to the circuit board 3, the circuit board 3 is disposed on the mold 2, and the main body 10 of the solder spray jig 1 is disposed under the mold 2, allowing the spray outlet 101 to spray the solder upwards. The circuit board 3 is provided with an attached component 31 and a plurality of electronic components 32, wherein the electronic components 32 have electrical pins 321 thereof being mounted to the circuit board 3. The mold 2 is formed with a plurality of openings 23 corresponding in position to the electrical pins 321 and a protruding portion 22 for accommodating the attached component 31. During a spraying process, when the main body 10 is being moved horizontally in relation to the mold 2 and the protruding portion 22 is in contact with at least one of the movable units 102, the movable units 102 are urged to expose the recesses 103 by means of the driving device 5, so as to allow the protruding portion 22 to pass through the recesses 103 of the main body 10 and allow the spray outlet 101 to keep abutting against the mold 2 during the movement of the main body 10, such that a sufficient amount of the solder can be sprayed to the electrical pins 321 to fix the electronic components 32 to the circuit board 3.

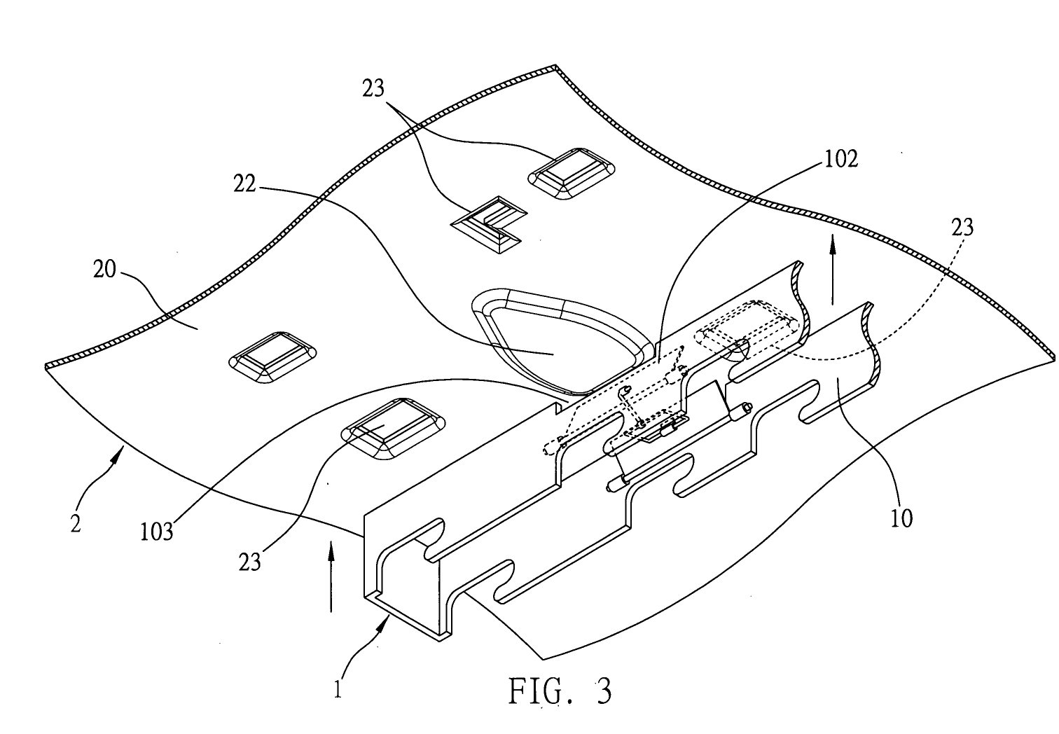

Referring to FIG. 3, during the spraying process where the spray outlet 101 abuts against the surface 21 of the mold 2 and the main body 10 is being moved horizontally in relation to the surface 21 of the mold 2, in order to prevent the main body 10 from being blocked by the protruding portion 22 of the mold 2, the movable units 102 mounted to the main body 10 are allowed to move in a path completely covering the protruding portion 22. When the spray outlet 101 is moved to a certain position where at least one of the movable units 102 is in contact with the protruding portion 22, the at least one of the movable units 102 is being pushed to allow both the operationally associated movable units 102 to flip to expose the recesses 103, such that the protruding portion 22 can pass through the main body 10 via the recesses 103, and the spray outlet 101 keeps abutting against the surface 21 of the mold 2.

Compared with the prior art where the jig must be spaced from the mold by a certain distance and causes an insufficient amount of solder being applied to the circuit board, the solder spray jig of the present invention can allow the spray outlet to keep abutting against a surface of the mold to provide sufficient solder to the circuit board and achieve an optimal spraying effect, thereby overcoming the drawbacks of the prior art.

Furthermore, when the conventional jig reaches the protruding portion of the mold, the revolution rate of the motor is increased to provide an increased solder spraying speed to apply a standard amount of solder to the circuit board. On the contrary, as the solder spray jig of the present invention keeps abutting against the mold, there is no need to increase a revolution rate of the motor but a sufficient amount of the solder can still be provided to the circuit board, thereby overcoming the drawbacks in the prior art such as increase in electricity consumption and solder usage.

Additionally, the solder spray jig of the present invention can be subjected to slight positional adjustment to be applied to various kinds of molds having protruding portions. The solder spray jig of the present invention is advantageously applicable to various kinds of molds.

The present invention has been described using exemplary preferred embodiments above, however, it is to be understood that the scope of the present invention is not limited to the disclosed embodiments. On the contrary, it is intended to cover various modifications and similar changes. The scope of the claims, therefore, should be accorded the broadest interpretation so as to encompass all such modifications and similar arrangements.

What is claimed is:

1. A solder spray jig comprising:
a main body comprising an opening acting as a spray outlet for solder, and recesses formed on two opposite sides of the main body and communicating with the spray outlet;
a movable unit disposed on each of the two opposite sides of the main body, for covering and exposing a corresponding one of the recesses; and
a driving device mounted to the movable units on the two opposite sides of the main body, for allowing the movable units to be operationally associated with each other to cover and expose the recesses;
wherein the spray outlet of the main body is allowed to abut against a mold that covers a circuit board and the main body is movable in relation to the mold, wherein the circuit board is provided with an attached component and a plurality of electronic components, and the mold is formed with openings corresponding in position to pins of the electronic components and a protruding portion for accommodating the attached component, such that when the main body is being moved in relation to the mold and the protruding portion of the mold is in contact with at least one of the movable units, the movable units are urged to expose the recesses by means of the driving device, so as to allow the protruding portion to pass through the recesses of the main body and allow the spray outlet to keep abutting against the mold in the movement of the main body.

2. The solder spray jig of claim 1, wherein the circuit board is disposed on the mold and the main body of the solder spray jig is disposed under the mold, allowing the spray outlet to spray the solder upwards.

3. The solder spray jig of claim 1, wherein the movable unit is a movable door pivotally mounted to the main body.

4. The solder spray jig of claim 1, wherein the driving device comprises a frame and a rod that are pivotally connected to each other, wherein the frame is pivotally connected to one of the movable units via an end of the frame that is free of being connected to the rod, and the rod is pivotally connected to the other one of the movable units via an end of the rod that is free of being connected to the frame.

5. The solder spray jig of claim 1, wherein the attached component is an attachment board.

6. The solder spray jig of claim 1, wherein the attached component is protruded from the circuit board by at least 12 mm.

7. The solder spray jig of claim 1, wherein the solder is extracted to a solder sprayer by a fluid dynamic bearing motor from a hotflow device where the solder is generated, and the solder is sprayed by the solder sprayer in the main body in a high speed.
